(19) United States
(12) Patent Application Publication
(10) Pub. No.: US 2012/0328765 A1
(43) Pub. Date: Dec. 27, 2012

(54) MINERAL FORTIFICATION AND ACIDIFICATION SUBSTANCE FOR FRUIT PREPARATIONS

(76) Inventors: AMR SHAHEED, HOWELL, NJ (US); ROSALEEN DOHERTY, PRINCETON, NJ (US)

(21) Appl. No.: 13/165,723

(22) Filed: Jun. 21, 2011

(51) Int. Cl. A23L 1/304

(52) U.S. Cl. 426/648

(57) ABSTRACT

The present invention relates to compositions comprising minerals which are soluble in fruit preparations. The compositions of the present invention dissolve in a fruit preparation without any cloudiness or sedimentation. Methods of making said compositions are also provided. Said compositions are useful in mineral fortification and acidification of fruit preparations.

### BACKGROUND OF THE INVENTION

The present invention relates to a composition comprising compounds containing biologically important minerals, such as calcium, magnesium and zinc, which are readily soluble in fruit preparations. Said fruit preparations may be consumed as is, or they may be added to dairy or other foods. Also, the present invention relates to a composition that acidifies said fruit preparations. Beneficially, the composition of the present invention does not alter the sensory properties of the fruit preparation. For example, a fruit preparation that is mineral fortified and acidified with the composition of the present invention may be added to a dairy food such as yogurt to enhance mineral content and shorten the fermentation time. Moreover, the organoleptic properties of said dairy food will not be adversely affected. Thus, the benefits of mineral fortification and acidification will be achieved without negatively altering the quality of the final product.

The process for preparing said composition involves combining one or more mineral portion containing compounds with one or more food grade acids to produce a free flowing, readily soluble granular solid composition. When used as a mineral fortification and acidification material in fruit preparations, the composition does not significantly alter the organoleptic properties of the fruit preparation or the product to which said fruit preparation is added.

Minerals are important to human health. Typically, health care providers classify minerals as essential and trace. Essential minerals include calcium, iron, magnesium, potassium, phosphorus and zinc. Trace minerals include chromium, copper, iodine, manganese, molybdenum and selenium. For example, calcium is an essential element in the human diet. Calcium plays a structural role as one of the components of bones and teeth. It is also an essential element in several physiological systems, such as blood clotting, cell membrane permeability and muscular contraction, including cardiac contractility. Because calcium is constantly being excreted, and the body cannot synthesize calcium, a human must consume sufficient dietary calcium to provide the body's daily requirement for calcium. The ability of humans to absorb and to use dietary calcium varies considerably and is a strong function of the other components of the diet. For example, if an individual ingests a high protein meal, typically around 15% of the calcium present in the food is absorbed by the body. On the other hand, when the diet is very low in protein, only about 5% of the dietary calcium is absorbed. Other factors in the diet can have similar effects. Phosphate metabolism is closely linked with calcium metabolism, and the concentration of one affects the absorption of the other. If either calcium or phosphate is present in the body in excess, as the body excretes the excess element, the excretion of the other is also increased.

Phosphorus is found in every cell in the body, but the majority of phosphorus is found associated with calcium in the bones and the teeth. Approximately 10% of the phosphorus in the body, in the form of phosphate, is present in combination with proteins, lipids, carbohydrates and with nucleic acids in DNA. Another 10% of the phosphorus in the body is widely distributed in a large variety of compounds throughout the body. In the cells of the body, phosphorus contributes to many important chemical reactions. For example, the energy necessary for metabolism is produced when the phosphate bonds of Adenosine Triphosphate (ATP) are broken.

Healthy bones require both calcium and phosphate. The mineral portion of bone is composed primarily of a calcium phosphate known as hydroxyapatite. Healthy bone is constantly being reformed through a process of dissolution and recrystallization of the hydroxyapatite. To operate properly, this process requires a constant source of calcium and phosphate.

Iron, magnesium, zinc and potassium also play significant roles in human health. Iron is incorporated into the haemoglobin molecule and, thus functions in oxygen transport to the cells making it important to energy production, collagen synthesis and proper immune functioning. Magnesium is essential to maintaining the acid/alkaline balance in the body and in nerve and muscle function, as well as bone growth. Zinc supports healthy immune function and protein synthesis. Potassium is critical to transmission of nerve impulses, muscle contractions and blood pressure maintenance.

Trace minerals also play a vital role in human health. For example, selenium is an antioxidant that works synergistically with Vitamin E. Recent research suggests that selenium supplements prevent free radical damage.

Fruit preparations and products such as yogurt that contain fruit preparations are widely consumed and mineral fortified fruit preparations and dairy products containing said mineral fortified fruit preparations would be attractive to health conscious consumers. However, adding minerals in their traditionally-available forms can alter the taste, appearance and other organoleptic properties of the food product.

### Description of the Related Art

Currently, a familiar fruit product producer offers a calcium fortified apple sauce product. Per the ingredient label, said product is fortified with calcium lactate and calcium gluconate. The lactate and gluconate species will greatly affect the flavor profile of the apple sauce and will also alter the pH of the finished apple sauce as both calcium salts tend to increase the pH. Increasing the pH could contribute to product instability from a microbiological stand point. On the other hand, Applicants' invention is more acidic in behaviour, and thus tends to reduce the pH of the apple sauce, tending to add stability to the product.

### SUMMARY OF THE INVENTION

The present invention relates to a process for producing a composition which may be used to mineral fortify and acidify fruit preparations, comprising the steps of:
(a) selecting a compound containing a mineral portion wherein the mineral portion of said compound is selected from the group consisting of calcium, zinc, and magnesium and mixtures thereof; and
(b) selecting an edible acid from the group consisting of phosphoric, lactic, malic, citric, tannic, fumaric, and gluconic and mixtures thereof; and
(c) combining said mineral portion containing compound (a). and said edible acid (b). to produce a composition wherein the proportion of said mineral portion containing compound (a) to said edible acid (b) in said composition is such that a 1 wt % solution of said composition has a turbidity of less than 10 NTU and a pH of between about 2.8 to about 3.2.

The present invention further relates to a process for producing a composition which may be used to mineral fortify and acidify fruit preparations, comprising the steps of:
(a) selecting a compound containing a mineral portion wherein the mineral portion of said compound is selected from the group consisting of calcium, zinc, and magnesium and mixtures thereof; and
(b) selecting an edible acid from the group consisting of phosphoric, lactic, malic, citric, tannic, fumaric, and gluconic and mixtures thereof; and
(c) combining said mineral portion containing compound (a), and said edible acid (b), to produce a composition wherein the proportion of said mineral portion containing compound (a) to said edible acid (b) in said composition is such that a 1 wt % solution of said composition is not susceptible to sedimentation and said composition has a pH of between about 2.8 to about 3.2.

Further, said process produces a free flowing, granular solid.

### DETAILED DESCRIPTION OF THE INVENTION

The present invention relates to a process for producing a composition which may be used to mineral fortify and acidify fruit preparations, comprising the steps of:
(a) selecting a compound containing a mineral portion wherein the mineral portion of said compound is selected from the group consisting of calcium, zinc, and magnesium and mixtures thereof; and
(b) selecting an edible acid from the group consisting of phosphoric, lactic, malic, citric, tannic, fumaric, and gluconic and mixtures thereof; and
(c) combining said mineral portion containing compound (a). and said edible acid (b). to produce a composition wherein the proportion of said mineral portion containing compound (a) to said edible acid (b) in said composition is such that a 1 wt % solution of said composition has a turbidity of less than 10 NTU and a pH of between about 2.8 to 3.2.

The present invention further relates to a process for producing a composition which may be used to mineral fortify and acidify fruit preparations, comprising the steps of:
(a) selecting a compound containing a mineral portion wherein the mineral portion of said compound is selected from the group consisting of calcium, zinc, and magnesium and mixtures thereof; and
(b) selecting an edible acid from the group consisting of phosphoric, lactic, malic, citric, tannic, fumaric, and gluconic and mixtures thereof; and
(c) combining said mineral portion containing compound (a). and said edible acid (b). to produce a composition wherein the proportion of said mineral portion containing compound (a) to said edible acid (b) in said composition is such that a 1 wt % solution of said composition is not susceptible to sedimentation and said composition has a pH of between about 2.8 to about 3.2.

Further, said process produces a free flowing, granular solid.

### Definitions and Usages of Terms

The term “fruit preparation” as used herein includes, but is not limited to, jams, jellies, preserves, conserves, chutneys, sauces or butters prepared from fruit that may be consumed as is or may be added to a product such as yogurt or kefir made from animal milk or non animal milk. The term “fruit preparation” also encompasses fruit purees used as fat substitutes for baking.

The term “animal milk” as used herein includes, but is not limited to, the milk of cows, goats, yaks, camels, water buffalo, reindeers and sheep and other ruminants.

The term “non animal milk” as used herein includes, but is not limited to, soy, rice, hemp, coconut, and almond milk.

The term “free flowing, granular solid”, as used herein, means any substance consisting of solid particles which is of, or is capable of being of, a flowing or running consistency.

The term “sedimentation” as used herein means the tendency for particles in suspension to settle out of the fluid in which they are entrained, and come to rest against a surface.

The term “turbidity” as used here in means the cloudiness or haziness of a fluid caused by individual particles (or suspended solids) that are generally not discretely visible to the naked eye. Fluid can contain suspended solid matter consisting of particles of many different sizes. While some suspended material will be large enough and heavy enough to settle rapidly to the bottom of the container if a liquid sample is left to stand (the settleable solids), very small particles will settle only very slowly, or not at all, if the sample is regularly agitated or the particles are colloidal. These small solid particles cause the liquid to appear cloudy or turbid.

(a) Mineral Containing Compounds Useful in the Practice of the Present Invention

The mineral containing compounds useful in the practice of the present invention are those compounds having a pH greater than 7 (i.e a basic pH). The mineral portion of said compound is selected from the group including, but not limited to, calcium, zinc, and magnesium and mixtures thereof. Said mineral containing compounds are dry.

In an embodiment of the invention, useful compounds containing the mineral calcium include, but are not limited to, dicalcium phosphate, tri calcium phosphate, monocalcium phosphate, and mixtures thereof. Said calcium mineral containing compounds are dry.

In an embodiment of the invention, useful compounds containing the mineral zinc include, but are not limited to, Zn(OH)₂, ZnHPO₄ and mixtures thereof. Said zinc mineral containing compounds are dry.

In an embodiment of the invention, useful compounds containing the mineral magnesium include, but are not limited to, MgCO₃, Mg(OH)₂, MgHPO₄ and mixtures thereof. Said magnesium mineral containing compounds are dry.

In an embodiment of the invention, a compound containing calcium metal such as dicalcium phosphate, a compound containing magnesium metal such as Mg(OH)₂ and a compound containing zinc metal such as ZnHPO₄ can be formulated into a flowable solid that is readily dissolved in fruit preparations for the purpose of mineral fortification and acidification. The organoleptic properties of the fruit preparation are not altered.

(b) Edible Acids Useful in the Practice of the Present Invention

Edible Acids useful in the Practice of the present invention include, but are not limited to, phosphoric, lactic, malic, citric, tannic, fumaric, and gluconic and mixtures thereof. In an embodiment of the invention, phosphoric, lactic, malic, citric, and gluconic are preferred. In another embodiment, phosphoric and fumaric are more preferred. In a further embodiment, phosphoric acid is preferred.

Preparing the Composition of the Present Invention

The present invention is prepared by combining the dry mineral portion containing compound with an edible acid until a free flowing solid forms. A 1.0 weight % solution of said free flowing solid has a turbidity of less than 10 NTU and a pH of between about 2.8 to 3.2 in a clear beverage application. In a fruit preparation, the composition of the present invention has a pH of 2.8 to about 3.2. The amount of the dry mineral portion containing compound and the amount of edible acid required to produce the free flowing, granular solid can be readily determined by one skilled in the art having access to molecular weight, valence, solubility and pKA data. The key to the present invention is that it does not require a first addition of water as in U.S. Pat. No. 6,569, 477 or the formation of a suspension as in U.S. Pat. No. 6,261,610 and US 2008/0268102. The desired dry mineral portion containing compound(s) and the food grade acid(s) are simply combined using mixing methods and equipment known to those skilled in the art, reducing processing effort.

In a preferred embodiment of the invention, useful compounds containing the mineral calcium include, but are not limited to, dicalcium phosphate or tricalcium phosphate. For example, said dicalcium phosphate or tricalcium phosphate is mixed with an edible acid for a sufficient period of time to allow the materials to react. The calcium phosphates may be in a hydrated or anhydrous form. Alternatively, combinations of monocalcium, dicalcium and/or tricalcium phosphate may be mixed with the edible acid for a sufficient time to allow the materials to react.

In one embodiment of the invention, dicalcium phosphate is combined with phosphoric acid to produce the composition. In a preferred embodiment, anhydrous dicalcium phosphate is provided and phosphoric acid is added to the anhydrous dicalcium phosphate over a period of time while mixing.

In a further embodiment, 85% phosphoric acid is added to the dicalcium phosphate. The materials may be mixed using conventional mixing equipment. The 85% phosphoric acid may be added to the dicalcium phosphate at an approximately constant rate over a sufficient period of time to allow complete mixing, typically, between about 30 minutes and 2 hours. The materials may be combined at ambient temperatures, although the process will produce heat and may cause the temperature of the combined materials to rise.

In another embodiment of the invention, hydrated dicalcium phosphate is combined with phosphoric acid to produce the composition. In a preferred embodiment, dicalcium phosphate dihydrate (CaHPO₄-2H₂O) is provided and phosphoric acid is added to the dicalcium phosphate dihydrate over a period of time while mixing. For example, 85% phosphoric acid is added to the dicalcium phosphate dihydrate. The materials may be mixed using conventional mixing equipment. The 85% phosphoric acid may be added to the dicalcium phosphate dihydrate at an approximately constant rate over a sufficient period of time to allow complete mixing, preferably between about 30 minutes and 2 hours. The materials may be combined at ambient temperatures, although the process will produce heat and may cause the temperature of the combined materials to rise.

In another embodiment of the invention, tricalcium phosphate is combined with phosphoric acid to produce the composition. In this embodiment, tricalcium phosphate is provided and phosphoric acid is added to the tricalcium phosphate over a period of time while mixing. In an embodiment, 85% phosphoric acid is added to the tricalcium phosphate. The materials may be mixed using conventional mixing equipment. The 85% phosphoric acid may be added to the tricalcium phosphate at an approximately constant rate over a sufficient period of time to allow complete mixing, preferably between about 30 minutes and 2 hours. The materials may be combined at ambient temperatures, although the process will produce heat and cause the temperature of the combined materials to rise.

When the phosphoric acid added to the dicalcium phosphate or tricalcium phosphate is less than 85% concentration, it may be necessary to add a drying step to the process to obtain solid material that flows well. In this case, the final product is preferably dried so that the weight loss at 100° C. is less than 1%.

In yet another embodiment of the invention, a mixture of dicalcium phosphate and tricalcium phosphate is combined with phosphoric acid to produce the composition. In a preferred embodiment, a blend of anhydrous dicalcium phosphate and tricalcium phosphate is provided and phosphoric acid is added to the dicalcium phosphate/tricalcium phosphate blend over a period of time while mixing. The dicalcium phosphate and tricalcium phosphate may be provided in any proportion of the two phosphates in the blend. In a preferred embodiment, 85% phosphoric acid is added to the dicalcium phosphate/tricalcium phosphate blend. The phosphoric acid and the dicalcium phosphate/tricalcium phosphate blend may be mixed using conventional mixing equipment. The 85% phosphoric acid may be added to the dicalcium phosphate/tricalcium phosphate blend at an approximately constant rate over a sufficient period of time to allow complete mixing, preferably between about 30 minutes and 2 hours. The materials may be combined at ambient temperatures, although the process will produce heat and cause the temperature of the combined materials to rise.

In still another embodiment of the invention, a blend of ZnHPO₄ and MgHPO₄ are combined with lactic acid to produce the free flowing solid composition of the present invention. For example, a blend of ZnHPO₄ and MgHPO₄ is provided and lactic acid is added to the blend of ZnHPO₄ and MgHPO₄ over a period of time while mixing. Conventional mixing equipment known to those skilled in the art is used. The lactic acid is added at a constant rate over a sufficient period of time to allow complete mixing, preferably between about 30 minutes and 2 hours. Mixing may occur at ambient temperatures, although the process will produce heat and cause the temperature of the combined materials to rise.

In an embodiment of the invention, ZnHPO4 and Mg(OH)2 are combined with a fumaric/phosphoric acid blend. Conventional mixing equipment, known to those skilled in the art, is used to combine the ZnHPO4, the Mg(OH)2, and the acid blend to achieve a flowable, granular powder.

In a further embodiment of the invention, ZnHPO₄, dicalcium phosphate, and Mg(OH)₂ are combined with a fumaric acid/phosphoric acid/citric acid blend. Conventional mixing equipment, known to those skilled in the art, is used to combine the ZnHPO₄, dicalcium phosphate , and Mg(OH)₂ with the acid blend to achieve a flowable powder.

It should be noted that the invention is not limited to a process whereby an edible acid is added to a mineral containing compound. In all of the embodiments of the invention described herein, the process can be performed in suitable mixing equipment by first providing an edible acid and then adding any mineral containing compound or mixtures thereof to said edible acid and mixing.

Although the product made by the process described above is a free flowing, granular solid, the flowability of the material can be improved if desired by mixing the final composition with tricalcium phosphate as a final step in the process. For example, dicalcium phosphate and phosphoric acid can be combined as described above to produce the composition of the invention. After the composition has been produced, tricalcium phosphate can be mixed with the composition as a flow aid. The tricalcium phosphate can be added in any amount required to give the final product the desired flow characteristics. In a preferred embodiment, the composition produced by the process of the present invention is mixed with tricalcium phosphate in the proportion of 95/5 weight to weight.

As discussed above, the material produced by the methods of the present invention can be dissolved in fruit preparations for the purpose of mineral fortifying and acidifying said fruit preparations. When said material is dissolved in fruit preparations, there is no sedimentation. Evaluating the visual appeal of fruit preparations is subjective. The appearance of a fruit preparation is dependent on the volume through which light passes before entering the eye, the background against which the sample is viewed, and the concentration of the material in fruit preparation. Also, while the human eye can detect whether or not one sample next to another is cloudier or more turbid than its neighbor, comparing samples is fraught with difficulty. Quantatative measurements can reduce the subjective nature of the evaluation. A quantitative method of measuring turbidity relies on the fact that the appearance of turbidity is due to the amount of light which is scattered by suspended particles. Measurements made with a turbidity meter measure the amount of scattered light, by measuring the amount of light at a detector which is placed at an angle (90 degrees) to the incident beam passing through the sample. The apparatus can be calibrated with purchased standards to allow measurements which are accurate and precise. The calibration standards allow one to report turbidity in Nephelometric Turbidity Units (NTU). The material produced by the process of the present invention can be dissolved in water to produce a 1 weight % solution with a turbidity of less than 10 NTU. The pH of the 1 weight % solution is preferably between about 2.8 and about 3.2.

The following non limiting embodiments illustrate the practice of the present invention.

### EXAMPLE 1

In a Hobart mixer, 200 g of dicalcium phosphate anhydrous is provided at a starting temperature of 20° C. While mixing, 200 g of 85% phosphoric acid at 20° C. was added over a period of one hour. After all of the phosphoric acid was added, the materials were mixed for a further 30 minutes. The product remained a free flowing, granular solid. Some heat was released during the reaction which raised the temperature of the final product to about 40° C. X-ray diffraction on the powder showed the material to contain MCP-1 (mono-calcium phosphate monohydrate) as the only crystalline compound. When this material was added to water it dissolved completely without any cloudiness and a turbidity of less than 5 NTU.

### EXAMPLE 2

In a Hobart mixer, 160 g of tricalcium phosphate (TCP) is provided at a starting temperature of 20° C. While mixing, 240 g of 85% phosphoric acid at 20° C. was added over a period of one hour. After all of the phosphoric acid was added, the materials were mixed for a further 30 minutes. The product remained a free flowing, granular solid. Some heat was released during the reaction which raised the temperature to about 50° C. X-ray diffraction on the powder showed the material to contain MCP-1 as the only crystalline compound. When this material was added to water it dissolved completely without any cloudiness and a turbidity of less than 5 NTU.

The composition produced by the process of the present invention may be used to mineral fortify and acidify fruit preparations. Because the composition is readily soluble, said fruit preparations can be mineral fortified and acidified to any desired level.

We claim:

1. A process for producing a composition which may be used to mineral fortify and acidify fruit preparations, comprising the steps of:
(a) selecting a compound containing a mineral portion wherein the mineral portion of said compound is selected from the group consisting of calcium, zinc, and magnesium and mixtures thereof; and
(b) selecting an edible acid from the group consisting of phosphoric, lactic, malic, citric, tannic, fumaric, and gluconic and mixtures thereof; and
(c) combining said mineral portion containing compound (a). and said edible acid (b). to produce a composition wherein the proportion of said mineral portion containing compound (a) to said edible acid (b) in said composition is such that a 1 wt % solution of said composition has a turbidity of less than 10 NTU and a pH of between about 2.8 to about 3.2.

2. A process for producing a composition which may be used to mineral fortify and acidify fruit preparations, comprising the steps of:
(a) selecting a compound containing a mineral wherein said compound containing a mineral is selected from the group consisting of dicalcium phosphate, tri calcium phosphate, monocalcium phosphate, Zn(OH)2, ZnHPO4, MgCO3, Mg(OH)2, MgH PO4 and mixtures thereof;
(b) selecting an edible acid from the group consisting of phosphoric, lactic, malic, citric, tannic, fumaric, and gluconic and mixtures thereof; and
(c) combining said mineral containing compound (a). and said edible acid (b). to produce a composition wherein the proportion of said mineral containing compound (a) to said edible acid (b) in said composition is such that a 1 wt % solution of said composition has a turbidity of less than 10 NTU and a pH of between about 2.8 to about 3.2.

3. A process for producing a free flowing, granular solid composition which may be used to mineral fortify and acidify fruit preparations, comprising the steps of:
(a) selecting a compound containing a mineral portion wherein the mineral portion of said compound is selected from the group consisting of calcium, zinc, and magnesium and mixtures thereof; and
(b) selecting an edible acid from the group consisting of phosphoric, lactic, malic, citric, tannic, fumaric, and gluconic and mixtures thereof; and
(c) combining said mineral portion containing compound (a). and said edible acid (b). to produce a composition wherein the proportion of said mineral portion containing compound (a) to said edible acid (b) in said composition is such that a 1 wt % solution of said composition is not susceptible to sedimentation and said composition has a pH of between about 2.8 to about 3.2.

4. A process for producing a free flowing, granular solid composition which may be used to mineral fortify and acidify fruit preparations, comprising the steps of:
(a) selecting a compound containing a mineral wherein said compound containing a mineral is selected from the group consisting of dicalcium phosphate, tri calcium phosphate, monocalcium phosphate, Zn(OH)2, ZnHPO4, MgCO3, Mg(OH)2, MgHPO4 and mixtures thereof;
(b) selecting an edible acid from the group consisting of phosphoric, lactic, malic, citric, tannic, fumaric, and gluconic and mixtures thereof; and
(c) combining said mineral containing compound (a). and said edible acid (b). to produce a composition wherein the proportion of said mineral containing compound (a) to said edible acid (b) in said composition is such that a 1 wt % solution of said composition is not susceptible to sedimentation and said composition has a pH of between about 2.8 to about 3.2.
